(19) United States
(12) Patent Application Publication
(10) Pub. No.: US 2026/0322202 A1
(43) Pub. Date: Oct. 15, 2026

(54) INSULATION MATERIAL AND ROTARY ELECTRIC DEVICE INCLUDING THE SAME

(71) Applicant: KCC CORPORATION, Seoul (KR)

(72) Inventors: Pung Koc HWANG, Iksan-si, Jeonbuk-do (KR); Chan Young PARK, Wanju-gun, Jeonbuk-do (KR); Ji Seung PARK, Wanju-gun, Jeonbuk-do (KR); Eui Hyeon KIM, Wanju-gun, Jeonbuk-do (KR)

(21) Appl. No.: 19/478,269

(22) PCT Filed: May 17, 2024
(86) PCT No.: PCT/KR2024/095800

§ 371 Date: Oct. 24, 2025

(30) Foreign Application Priority Data
Jul. 5, 2023 (KR) 10-2023-0087041

(51) Int. Cl. H02K 3/30; C08G 59/24; C08G 59/32; C08G 59/38; C08G 59/62; H02K 3/34

(52) U.S. Cl. CPC H02K 3/30; C08G 59/24; C08G 59/245; C08G 59/3218; C08G 59/38; C08G 59/621; H02K 3/345

(57) ABSTRACT

The present invention provides an insulation material having excellent insulation and heat resistance. The insulation material according to the present invention may be filled between a slot and a coil in a rotary electric device to fill a gap between the slot and the coil and provide insulation properties by replacing an insulation paper. The insulation material of the present invention may be applied to a rotary electric device, such as a motor for an electric vehicle, in which a large torque is required to increase a rotation speed and a current applied to a stator.

### TECHNICAL FIELD

The present invention relates to an insulation material and a rotary electric device including the same.

### BACKGROUND ART

A rotary electric device such as a motor or a generator includes a rotor and a stator, and the stator includes an annular stator core having a plurality of slots in a circumferential direction of an inner circumferential surface. A coil is wound in the slots, and an insulating layer for securing electrical insulation is formed between the slots and the coil in the stator.

The method of forming an insulating layer by inserting an insulating sheet between the slots and the coil in the stator has been conventionally used. In order to insert the insulating paper into the rotary electric device according to the method, a process of unwinding and supplying the insulating paper, cutting the insulating paper, bending the insulating paper to have a predetermined shape, and inserting the insulating paper into slots in the rotary electric device is required. Various technologies have been proposed in relation to the insulating paper and an apparatus for manufacturing the same, and for example, Korean Laid-Open Patent Publication No. 10-1999-0015205 discloses an insulating paper for a motor in which both wings and a fixing member for fixing the wings are integrated, and an apparatus for manufacturing the same.

However, since one manufacturing device manufactures one shape of an insulating paper, a separate insulating paper manufacturing device should be used for each shape in order to manufacture various shapes of insulating paper used in various types of rotary electric devices, and as a result, there is a problem of causing remarkable inefficiency in terms of cost and time.

### DETAILED DESCRIPTION OF INVENTION

### Technical Problem

The present invention is directed to providing an insulation material having excellent insulation and heat resistance. In addition, the present invention is directed to providing a rotary electric device provided with the insulation material.

### Technical Solution

The present invention provides an insulation material provided between a slot and a coil in a stator of a motor and formed by curing an epoxy resin composition containing an epoxy resin, a curing agent, and a filler, wherein the insulation material has a high-temperature mass reduction rate of less than 2.0 wt % when a cycle of standing and exposure in an oven at a temperature of 275° C. for 24 hours is performed 5 times.

### Advantageous Effects

The present invention provides an insulation material having excellent insulation and heat resistance. The insulation material according to the present invention can charge between a slot and a coil in the rotating electrical device to fill a gap between the slot and the coil and replace the insulating paper, thereby providing insulation characteristics. The insulation material of the present invention has excellent insulating properties and heat resistance and thus can be applied to a rotary electric device in which a rotational speed and a current applied to the stator are increased due to a large required torque, such as a motor for an electric vehicle.

### BEST MODE

Hereinafter, the present invention will be described in detail. However, the scope of the present invention is not limited only by the following description, and each component may be variously modified or selectively mixed as necessary. Therefore, it should be understood that all modifications, equivalents, and substitutes included in the spirit and technical scope of the present invention are included.

As used herein, “viscosity” is measured by the conventional methods known in the art and may be measured, for example, using an ICI viscometer at a temperature of 150° C. A functional group such as a “hydroxyl group” is measured by the conventional methods known in the art and, for example, may be measured by a titration method. A “particle size (D50)” is measured by the conventional method known in the art, and may be measured by, for example, laser light scattering (LLS).

### <Insulation Material>

The insulation material of the present invention is provided between a slot and a coil in a stator of a motor and formed by curing an epoxy resin composition containing an epoxy resin, a curing agent, and a filler, and when a cycle of standing and exposure in an oven at a temperature of 275° C. for 24 hours is performed 5 times, a high-temperature mass reduction rate is less than 2.0 wt %, for example, less than 1.5 wt %, or in another example, less than 1.0 wt %. The high-temperature mass reduction rate is calculated by the following equation.

High-temperature mass reduction rate (%)=[(W₀−W_{5cycle})/W₀]×100

In the above equation, W₀ is a mass of the cured insulation material, and W_{5cycle} cycle is a mass of the insulation material after 5 cycles.

The insulation material of the present invention is formed by curing an epoxy resin composition and serves to replace the conventional insulating paper. The epoxy resin composition may be molded to have a thin thickness (for example, about 25 μm) between the slot and the coil in the stator of the motor, and thus, when a resin component is decomposed due to high-temperature thermal decomposition, the thickness of a corresponding portion may be reduced, and thus electrical insulation characteristics may be deteriorated. The insulation material according to the present invention is excellent in heat resistance with a high-temperature mass reduction rate of less than 2.0 wt % and may provide excellent insulation when applied to a rotary electric device that is continuously exposed to a high-temperature environment.

The epoxy resin composition according to the present invention contains an epoxy resin, a curing agent, and a filler.

For example, the epoxy resin may contain a dicyclopentadiene-type epoxy resin, a phenol aralkyl-type epoxy resin, or a mixture thereof. In addition, the epoxy resin may further contain various known epoxy resins in a range in which properties of the epoxy resin composition of the present invention are not inhibited.

Meanwhile, the epoxy resin composition may further contain an additive commonly used in the art, such as an adhesion improver, a release agent, a curing accelerator, a colorant, a flame retardant, and the like as necessary.

### Dicyclopentadiene-Type Epoxy Resin

The epoxy resin composition of the present invention may contain a dicyclopentadiene-type epoxy resin as an epoxy resin. The dicyclopentadiene-type epoxy resin may be cured by reacting with a curing agent to form a three-dimensional network structure, thereby imparting properties that are strongly and firmly adhered to an adherend and heat resistance.

In the case of a general thermosetting resin, thermal decomposition occurs at a high temperature of 200° C. or higher and a mass is reduced, which results in a problem that electrical insulation of the thermosetting resin is rapidly deteriorated. In the present invention, by using a dicyclopentadiene-type epoxy resin containing dicyclopentadiene having a substituent having a larger molecular structure than a bisphenol-based or ortho-cresol novolac-based epoxy resin that is universally used, it is possible to prevent the molecular structure from being decomposed even when exposed to a harsh environment (high temperature, etc.) due to the substituent.

Therefore, the epoxy resin composition of the present disclosure includes a dicyclopentadiene-type epoxy resin containing dicyclopentadiene having a bulky structure so that excellent heat resistance can be secured, thermal decomposition can be prevented at a high temperature to prevent the mass reduction, and reduction of electrical insulation can be prevented.

The dicyclopentadiene-type epoxy resin may be expressed by the following formula 1.

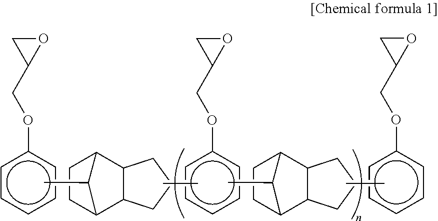

In chemical formula 1, n is an integer of 1 to 10.

When the dicyclopentadiene-type epoxy resin in which n exceeds 10 is used, a viscosity of the epoxy resin composition increases, causing dispersibility and moldability to deteriorate, and when cured, the epoxy resin is entangled with a curing agent in a tight mesh structure, which degrades brittleness and may cause durability to deteriorate.

An epoxy equivalent weight of the dicyclopentadiene-type epoxy resin may range from 200 g/eq to 300 g/eq, for example, from 250 g/eq to 280 g/eq. When the epoxy equivalent weight is less than the above-described range, high-temperature thermal decomposition characteristics may deteriorate, and when the epoxy equivalent weight exceeds the above-described range, a glass transition temperature (Tg) of the composition may be lowered and mechanical properties may deteriorate.

A viscosity (150° C.) of the dicyclopentadiene-type epoxy resin may range from 0.1 poises to 10 poises, for example, from 0.1 poises to 4 poises. When the viscosity is less than the above-described range, high-temperature thermal decomposition characteristics may deteriorate, and when the viscosity exceeds the above-described range, the overall viscosity of the epoxy resin composition may increase, causing dispersibility with a filler to deteriorate, and since the insulating layer is not properly formed between the slot and the coil of the stator, insulation properties may not be sufficiently provided and therefore product reliability may be deteriorate.

A content of the dicyclopentadiene-type epoxy resin may range from 1 wt % to 20 wt %, for example, from 1 wt % to 10 wt % with respect to the total weight of the epoxy resin composition. When the content of the dicyclopentadiene-type epoxy resin is less than the above-described range, high-temperature thermal decomposition characteristics may deteriorate, and when the content of the dicyclopentadiene-type epoxy resin exceeds the above-described range, a content of the filler may be reduced and mechanical strength may deteriorate.

### Phenol Aralkyl Type Epoxy Resin

The epoxy resin composition of the present invention may contain a phenol aralkyl type epoxy resin as an epoxy resin. The phenol aralkyl type epoxy resin may be cured by reacting with a curing agent to form a three-dimensional network structure, thereby imparting a property of strongly and firmly adhering to the adherend and flame retardancy. The phenol aralkyl type epoxy resin has a structure including biphenyl in the middle based on a phenol skeleton, has excellent hygroscopicity, toughness, oxidation resistance, and crack resistance, and has a low crosslinking density to form a carbon layer (char) during combustion at a high temperature to block transmission of surrounding heat and oxygen, thereby imparting flame retardancy.

The phenol aralkyl type epoxy resin may be expressed by the following formula 2.

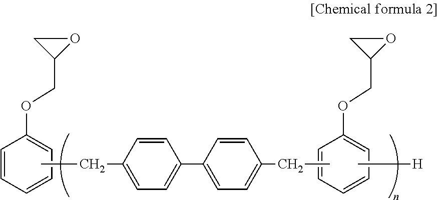

In chemical formula 2, n is an integer of 1 to 10.

An epoxy equivalent weight of the phenol aralkyl type epoxy resin may range from 250 g/eq to 400 g/eq, for example, from 270 g/eq to 290 g/eq. When the epoxy equivalent weight is less than the above-described range, flame retardant characteristics may deteriorate, and when the epoxy equivalent weight exceeds the above-described range, mechanical properties may deteriorate.

A viscosity (150° C.) of the phenol aralkyl type epoxy resin may range from 0.01 poises to 10 poises, for example, from 0.05 poises to 3.0 poises. When the viscosity is less than the above-described range, the flame-retardant characteristics may deteriorate, and when the viscosity exceeds the above-described range, a glass transition temperature (Tg) of the epoxy resin composition may be lowered and the mechanical properties may deteriorate.

A content of the phenol aralkyl type epoxy resin may range from 0.1 wt % to 10 wt %, for example, from 0.1 wt % to 5 wt % with respect to the total weight of the epoxy resin composition. When a content of the phenol aralkyl type epoxy resin is less than the above-described range, flame retardant characteristics may deteriorate, and when the content of the phenol aralkyl type epoxy resin exceeds the above-described range, mechanical properties and adhesion characteristics with metals may deteriorate.

For example, the epoxy resin composition of the present invention may include a dicyclopentadiene-type epoxy resin, a phenol aralkyl-type epoxy resin, or a mixture thereof as an epoxy resin. A mixing ratio of the dicyclopentadiene-type epoxy resin and the phenol aralkyl-type epoxy resin may be a weight ratio of 0 to 100:100 to 0, for example, 10 to 50:1.

### Other Epoxy Resins

In addition to the dicyclopentadiene-type epoxy resin and the phenol aralkyl-type epoxy resin, the epoxy resin composition of the present invention may further include another epoxy resin in order to complement a bonding force and adhesion of the epoxy resin composition within a range that does not hinder properties of the insulation material of the present invention.

As the epoxy resin, an epoxy resin commonly used in the art may be used, and for example, an epoxy resin containing two or more epoxy groups in a molecular structure may be used. Non-limiting examples of the usable epoxy resin may include a bisphenol-based epoxy resin, a cyclic epoxy resin, a cresol novolac-type epoxy resin, a biphenyl-type epoxy resin, a naphthalene-type epoxy resin, a polyfunctional epoxy resin, an anthracene-type epoxy resin, a non-condensed cyclic polycyclic structure epoxy resin, a bisphenol fluorene-modified epoxy, and the like and may further include at least one thereof.

The total content of the dicyclopentadiene-type epoxy resin, the phenol aralkyl-type epoxy resin, and the other epoxy resin contained in the epoxy resin composition according to the present invention may range from 1 to 20 wt %, for example, from 3 to 12 wt %, and in another example, 5 to 10 wt %, with respect to the total weight of the epoxy resin composition. When the total content of the dicyclopentadiene-type epoxy resin, the phenol aralkyl-type epoxy resin, and the other epoxy resin is less than the above-described range, the components may not be bonded, coagulated, and coupled when the epoxy resin composition is cured, causing cracks or degrading in durability, and when the total content thereof exceeds the above-described range, the resin component may be thermally decomposed when exposed to a high temperature, which may increase a high-temperature mass reduction rate and degrade insulation properties and durability, and therefore cracks may occur or damage may occur even with minor external impacts.

### Curing Agent

The epoxy resin composition according to the present invention includes a curing agent. The curing agent may react with the epoxy resin, and through the curing process, the cured material closely adheres to and fills the space between the coil wound in the slots and the slot of the stator, thereby imparting insulation characteristics to the stator.

As the curing agent, any curing agent known in the art that performs a curing reaction with the epoxy resin may be used, and for example, the curing agent may be a phenolic compound having two or more phenolic hydroxyl groups in one molecule. For example, the curing agent may include one or more selected from the group consisting of an acid anhydride compound, a phenol novolac resin, a cresol novolac resin, a phenol aralkyl resin, and a polyfunctional phenol compound.

As the curing agent, a curing agent having a hydroxyl group equivalent weight of 120 g/eq to 200 g/eq, for example, 160 g/eq to 180 g/eq may be used. When the hydroxyl group equivalent weight is less than the above-described range, an adhesive force of the epoxy resin composition may deteriorate, and when the hydroxyl group equivalent weight exceeds the above-described range, the glass transition temperature (Tg) of the epoxy resin composition may be lowered, and mechanical properties may deteriorate.

The curing agent may have a viscosity (150° C.) of 0.1 poises to 5 poises, for example, 0.5 poises to 2 poises. When the viscosity is less than the above-described range, the adhesive strength of the epoxy resin composition may deteriorate, and when the viscosity exceeds the above-described range, the glass transition temperature (Tg) of the epoxy resin composition may be lowered, and the mechanical properties may deteriorate.

The curing agent may have an electrical conductivity of 25 μs/cm or less. When the electrical conductivity exceeds the above-described range, electrical insulation properties may deteriorate.

As the curing agent, a curing agent having volatile matter of 1% or less, for example, 0.2% or less may be used. When the volatile matter exceeds the above-described range, high-temperature thermal decomposition characteristics may deteriorate.

A content of the curing agent may range from 0.1 wt % to 15 wt %, for example, from 1 wt % to 10 wt %, with respect to the total weight of the epoxy resin composition. When the content of the curing agent is less than the above-described range, curability and moldability may deteriorate, and when the content of the curing agent exceeds the above-described range, reliability and strength may deteriorate due to an increase in moisture absorption.

### Filler

The epoxy resin composition according to the present invention includes a filler. The filler imparts strength to the epoxy resin composition and controls flowability.

A filler commonly used in the art may be used as the filler without limitation, and for example, inorganic fillers such as silica, silica nitride, alumina, aluminum nitride, boron nitride, and the like may be used, and these may be used alone or in a combination of two or more thereof. A shape of the filler is not particularly limited, and both an angular shape and a spherical shape may be used.

The filler may include two types of fillers having different particle diameters. For example, the filler may include a first filler having an average particle diameter (D50) of 3 μm to 14 μm, for example, 7 μm to 14 μm, and a second filler having an average particle diameter (D50) of 14.5 μm to 30 μm, for example, 14.5 μm to 21.5 μm.

A content of the filler may range from 50 wt % to 95 wt %, for example, from 81 wt % to 90 wt %, with respect to the total weight of the epoxy resin composition. When the content of the filler is less than the above-described range, moisture absorption in the cured product of the epoxy resin composition may be increased, causing reliability to deteriorate, and when the epoxy resin composition is exposed to a high temperature, the resin may be decomposed due to an excessive resin content, causing a high-temperature mass reduction rate to increase and insulating properties to deteriorate, and when the content of the filler exceeds the above-described range, fluidity may be reduced and formability may deteriorate.

### Additive

The epoxy resin composition according to the present invention may further include additives commonly used in the art, such as an adhesion improver, a release agent, a curing accelerator, a colorant, a flame retardant, and the like as necessary.

The adhesion improver is for improving adhesion between an organic-inorganic bond and a metal substrate and may include epoxy silane, amino silane, mercapto silane, acryl silane, vinyl silane, and the like. Both-terminal amine-modified silicone oil, paraffin wax, carnauba wax, polyethylene wax, ester wax, a long-chain fatty acid, and a metal salt of a long-chain fatty acid may be used as the release agent. In addition, an imidazole compound, an amine compound, an organic phosphine compound, and the like may be used as a curing accelerator for improving a curing speed and workability. In addition, additives such as colorants (e.g., carbon black, bengala, etc.) for imparting colors to the resin composition, flame retardants (e.g., metal hydroxide, etc.), and the like may be included.

The additive may be added within a content range that does not inhibit the properties of the epoxy resin composition of the present invention and, for example, may be included in the range of 0.01 wt % to 10 wt % respectively, with respect to the total weight of the epoxy resin composition, but not limited thereto.

### <Rotary Electric Device>

The present invention provides a rotary electric device having the above-described insulation material. The rotary electric device may be a vehicle component.

For example, there is provided the rotary electric device including a rotor and a stator, wherein the stator includes an annular stator core having a plurality of slots in a circumferential direction of an inner circumferential surface thereof, a coil is wound in the slots, and an insulation material according to the present invention is provided between the slots and the coil.

The insulation material according to the present invention has excellent insulating properties and heat resistance, and thus may be applied as an insulation material for imparting insulating properties to a rotary electric device in which a rotational speed and a current applied to the stator are increased due to a large required torque, such as a motor for an electric vehicle.

### MODES OF THE INVENTION

Hereinafter, the present invention will be described in more detail with reference to examples. However, the following examples are merely to assist understanding of the present invention, and the scope of the present invention is not limited to the examples.

### Examples 1-11

Each component was mixed according to a composition shown in the following tables 1 and 2 to prepare an epoxy resin composition of each Test example.

TABLE 1

| Components (wt %) | Ex. 1 | Ex. 2 | Ex. 3 | Ex. 4 | Ex. 5 | Ex. 6 |
|---|---|---|---|---|---|---|
| Epoxy resin 1 | 5.4 | 7.4 | 9.4 | 12.1 | 7.8 | 6.8 |
| Epoxy resin 2 | 0.4 | 0.4 | 0.4 | 0.4 | | 1.0 |
| Epoxy resin 3 | | | | | | |
| Epoxy resin 4 | | | | | | |
| Curing agent | 2.8 | 3.8 | 4.8 | 6.1 | 3.8 | 3.8 |
| Filler | 90 | 87 | 84 | 80 | 87 | 87 |
| Silane | 0.3 | 0.3 | 0.3 | 0.3 | 0.3 | 0.3 |
| Wax | 0.2 | 0.2 | 0.2 | 0.2 | 0.2 | 0.2 |
| Colorant | 0.2 | 0.2 | 0.2 | 0.2 | 0.2 | 0.2 |
| Catalyst | 0.4 | 0.4 | 0.4 | 0.4 | 0.4 | 0.4 |
| Flame retardant | 0.3 | 0.3 | 0.3 | 0.3 | 0.3 | 0.3 |
| Sum | 100 | 100 | 100 | 100 | 100 | 100 |

TABLE 2

| Components (wt %) | Ex. 7 | Ex. 8 | Ex. 9 | Ex. 10 | Ex. 11 |
|---|---|---|---|---|---|
| Epoxy resin 1 | | | | | 15.3 |
| Epoxy resin 2 | 7.8 | 0.4 | 0.4 | | 0.4 |
| Epoxy resin 3 | | 7.2 | | 7.2 | |
| Epoxy resin 4 | | | 7.2 | 0.6 | |
| Curing agent | 3.8 | 4 | 4 | 3.8 | 7.9 |
| Filler | 87 | 87 | 87 | 87 | 75 |
| Silane | 0.3 | 0.3 | 0.3 | 0.3 | 0.3 |
| Wax | 0.2 | 0.2 | 0.2 | 0.2 | 0.2 |
| Colorant | 0.2 | 0.2 | 0.2 | 0.2 | 0.2 |
| Catalyst | 0.4 | 0.4 | 0.4 | 0.4 | 0.4 |
| Flame retardant | 0.3 | 0.3 | 0.3 | 0.3 | 0.3 |
| Sum | 100 | 100 | 100 | 100 | 100 |

Epoxy resin 1: dicyclopentadiene (DCPD) type epoxy resin (EEW 259 g/eq, viscosity (150° C.) 0.8 poises)

Epoxy resin 2: phenol aralkyl type epoxy resin (EEW 274 g/eq, viscosity (150° C.) 0.1 poises)

Epoxy resin 3: ortho-cresol novolac-type epoxy resin (EEW 208 g/eq, viscosity (150° C.) 2.8 poises)

Epoxy resin 4: bisphenol A type epoxy resin (EEW 191 g/eq, viscosity (150° C.) 0.02 poises)

Curing agent: phenol polymer with 1,4-bis(methoxymethyl)benzene (viscosity (150° C.) 0.95 poises, electrical conductivity of 9 μs/cm, OH equivalent weight of 170 g/eq, volatility of 0.1%)

Filler: silica (D50 7-14 μm_30 wt %, D50 14.5-21.5 μm_70 wt %)

Silane: trimethoxy [3-(phenylamino) propyl]silane

Wax: ester wax

Colorant: carbon black

Catalyst: triphenylphosphine imidazol

Flame retardant: (carbonato) hexadecahydroxydialuminum-hexamagnesium

### [Property Evaluation]

The properties of the epoxy resin composition of each example were measured by the following method, and the results are shown in the following tables 3 and 4.

### Spiral Flow (S/F)

A mold press was set to a temperature of 175° C. and tested under the following conditions at an actual mold temperature of 170±5° C.
Transfer pressure: 1,000±25 psi
Transfer speed: 1 to 4 inches/sec
Curing time: 120 sec

When measured using a spiral flow measurement mold defined in ASTM D 3123-72, a sample was taken to have a cull thickness of 3±0.5 mm, and then a spiral flow value was measured.

### Gel Time (G/T)

A hot plate preheated to a temperature of 170±3° C. was thinly coated with 2 g of the epoxy resin composition of each example using a spatula, and then a time at which curing started and the coated layer started to break was measured.

### High-Temperature Mass Reduction Rate

10 ea of a specimen having a diameter of 30 mm×a thickness of 2 mm was prepared using a transfer molding facility, and a weight (W₀) was measured. A process of heating the specimen in a drying oven at a temperature of 275° C. for 24 hours and cooling the specimen to room temperature (1 cycle) was repeated n times, a weight (W_{ncycle}) was measured, and a high-temperature mass reduction rate was calculated according to the following formula.

High-temperature mass reduction rate (%): [(W₀−W_{ncycle})/W₀]×100

### Adhesive Force (Cu)

The epoxy resin composition of each example was molded on a Cu specimen in a cylindrical shape having a diameter of 5.5 mm, and then an adhesive force was measured using a die shear tester. Molding conditions identical to the spiral flow measurement conditions were used.

### Withstanding Voltage Test (Leakage Current Evaluation)

A withstanding voltage test was performed using the 5-cycle-completed specimen used when evaluating the high-temperature mass reduction rate. Electrodes were connected back and forth based on a thickness surface of each specimen, and a voltage of 2.2 kV was applied for one minute. When a leakage current generated for one minute during which the voltage of 2.2 KV was applied was 50 mA or more, it was evaluated as a fail, and when the leakage current was less than 50 mA, it was evaluated as a pass.

TABLE 3

| Items | | Ex. 1 | Ex. 2 | Ex. 3 | Ex. 4 | Ex. 5 | Ex. 6 |
|---|---|---|---|---|---|---|---|
| S/F | Inches | 26 | 46 | 53 | 68 | 43 | 40 |
| G/T | sec | 31 | 33 | 33 | 35 | 32 | 32 |
| High-temperature | 1 cycle | 0.44 | 0.57 | 0.68 | 0.84 | 0.60 | 0.55 |
| mass reduction | 2 cycles | 0.63 | 0.74 | 0.89 | 1.05 | 0.80 | 0.73 |
| rate (%) | 3 cycles | 0.72 | 0.84 | 1.03 | 1.31 | 0.88 | 0.82 |
| (@275 °C × 24 hrs) | 4 cycles | 0.79 | 0.92 | 1.19 | 1.56 | 0.96 | 0.91 |
| | 5 cycles | 0.85 | 0.98 | 1.3 | 1.74 | 1.03 | 0.95 |
| Adhesive force | MPa | 12.1 | 13.8 | 13.8 | 14.1 | 14.5 | 11.8 |
| (Cu) | | | | | | | |
| Withstanding | Fail when | Pass | Pass | Pass | Pass | Pass | Pass |
| voltage test | leakage | Leakage | Leakage | Leakage | Leakage | Leakage | Leakage |
| | current of | current of | current of | current of | current of | current of | current of |
| | 50 mA or | 0 mA | 0 mA | 4 mA | 12 mA | 3 mA | 0 mA |
| | more | | | | | | |
| | occurs | | | | | | |

TABLE 4

| Items | | Ex. 7 | Ex. 8 | Ex. 9 | Ex. 10 | Ex. 11 |
|---|---|---|---|---|---|---|
| S/F | Inches | 39 | 32 | 47 | 35 | 85 |
| G/T | sec | 32 | 32 | 33 | 33 | 36 |
| High-temperature | 1 cycle | 0.51 | 1.02 | 1.1 | 1.05 | 1.26 |
| mass reduction | 2 cycles | 0.71 | 1.5 | 1.71 | 1.6 | 1.68 |
| rate (%) | 3 cycles | 0.80 | 1.9 | 2.05 | 2.01 | 1.99 |
| (@275 °C × 24 hrs) | 4 cycles | 0.89 | 2.26 | 2.38 | 2.31 | 2.24 |
| | 5 cycles | 1.01 | 2.52 | 2.66 | 2.65 | 2.43 |
| Adhesive force | MPa | 9.6 | 11.5 | 11 | 11.3 | 14 |
| (Cu) | | | | | | |
| Withstanding | Fail when | Pass | Fail | Fail | Fail | Fail |
| voltage test | leakage | Leakage | Leakage | Leakage | Leakage | Leakage |
| | current of | current of | current of | current of | current of | current of |
| | 50 mA or | 13 mA | 50 mA or | 50 mA or | 50 mA or | 50 mA or |
| | more | | more | more | more | more |
| | occurs | | | | | |

As shown in Tables 3 and 4, the insulation materials of examples 1 to 7, in which the epoxy resin composition according to the present invention having a high-temperature mass reduction rate of less than 2 wt % was cured, had excellent adhesive force and insulation properties. On the other hand, in the case of the insulation material of examples 8 to 11, in which the high-temperature mass reduction rate was 2 wt % or more, a leakage current generated was 50 mA or more due to low insulation resistance, exhibiting very low insulation properties.

### INDUSTRIAL APPLICABILITY

The present invention provides an insulation material having excellent insulation and heat resistance. In addition, the present invention provides a rotary electric device provided with the insulation material.

1. An insulation material that is provided between a slot and a coil in a stator of a motor and formed by curing an epoxy resin composition comprising an epoxy resin, a curing agent, and a filler, wherein the insulation material has a high temperature mass loss rate of less than 2.0 wt % when a cycle of standing and exposure in an oven at a temperature of 275° C. for 24 hours is performed 5 times:
high-temperature mass reduction rate (%)=[(W₀−W_{5cycle})/W₀]×100;
in the above equation,
W₀ is a mass of the cured insulation material, and
W_{5cycle} is a mass of the insulation material after 5 cycles.

2. The insulation material of claim 1, wherein the epoxy resin comprises a dicyclopentadiene type epoxy resin, and an epoxy equivalent weight of the dicyclopentadiene type epoxy resin ranges from 200 g/eq to 300 g/eq, and a viscosity (150° C.) ranges from 0.1 poises to 10 poises.

3. The insulation material of claim 1, wherein the epoxy resin comprises a phenol aralkyl type epoxy resin, and an epoxy equivalent weight of the phenol aralkyl type epoxy resin ranges from 250 g/eq to 400 g/eq, and a viscosity (150° C.) ranges from 0.01 poises to 10 poises.

4. The insulation material of claim 1, wherein the epoxy resin comprises a dicyclopentadiene-type epoxy resin, a phenol aralkyl-type epoxy resin, or a mixture thereof, and a mixing ratio of the dicyclopentadiene-type epoxy resin and the phenol aralkyl-type epoxy resin is a weight ratio of 0 to 100:100 to 1.

5. The insulation material of claim 1, wherein the curing agent comprises one or more selected from the group consisting of an acid anhydride, a phenol novolac resin, a cresol novolac resin, a phenol aralkyl resin, and a polyfunctional phenol, and
a hydroxyl equivalent weight of the curing agent ranges from 120 g/eq to 200 g/eq, a viscosity (150° C.) ranges from 0.1 poises to 5 poises, an electrical conductivity is 25 μs/cm or less, and volatile matter is 1% or less.

6. The insulation material of claim 4, wherein, with respect to the total weight of the epoxy resin composition, 1 wt % to 20 wt % of the dicyclopentadiene type epoxy resin, 0.1 wt % to 10 wt % of the phenol aralkyl type epoxy resin, 0.1 wt % to 15 wt % of the curing agent, and 50 wt % to 95 wt % of the filler are included.

7. A rotary electric device comprising a rotor and a stator,
wherein the stator comprises an annular stator core having a plurality of slots in a circumferential direction of an inner circumferential surface thereof,
a coil is wound in the slots, and
the insulation material according to claim 1 is provided between the slots and the coil.
